(19) United States
(12) Patent Application Publication
(10) Pub. No.: US 2024/0106178 A1
(43) Pub. Date: Mar. 28, 2024

(54) SLIP RING MODULE

(71) Applicants: DR. JOHANNES HEIDENHAIN GmbH, Traunreut (DE); LTN Servotechnik GmbH, Otterfing (DE)

(72) Inventors: Volker WEBER, Bergen (DE); Günther SCHOPPEL, Buchloe (DE)

(21) Appl. No.: 18/471,743

(22) Filed: Sep. 21, 2023

(30) Foreign Application Priority Data
Sep. 26, 2022 (EP) 22197637.6

(51) Int. Cl. H01R 39/08; B33Y 80/00

(52) U.S. Cl. CPC H01R 39/08; B33Y 80/00

(57) ABSTRACT

A slip ring module includes a plurality of electrically conductive elements and a dielectric support body. The material of the dielectric support body includes a ceramic material. The slip ring module is produced by an additive method such that each electrically conductive element is formed as a single piece, has a first region arranged as a slip ring, and a second region arranged as a connecting conductor. The dielectric support body has webs between which cavities are located.

### CROSS-REFERENCE TO RELATED APPLICATIONS

The present application claims priority to Application No. 22197637.6, filed in the European Patent Office on Sep. 26, 2022, which is expressly incorporated herein in its entirety by reference thereto.

### FIELD OF THE INVENTION

The present invention relates to a slip ring module.

### BACKGROUND INFORMATION

A slip ring unit may include a slip ring module, e.g., arranged as a rotor, and another assembly, e.g., arranged as a stator. The stator may include at least one brush unit, while the rotor or, e.g., the slip ring module may include a series of slip rings. During operation, brushes of the brush units have sliding contact mostly with the shell sides of the rotating slip rings. Slip ring units of this type are used in many technical fields to transmit electrical signals or electrical power between a stationary and a rotating electrical unit.

PCT Patent Document No. WO 2019/141351 describes a method for producing a slip ring module, in which electrically conductive elements are first produced together with a shell from the same material by an additive production method. Electrically insulating material is added into this shell, which material is then thermally cured. Thereafter, the shell is at least partially removed.

### SUMMARY

Example embodiments of the present invention provide a slip ring module that permits simple and economical production and that is of high quality, for example, with regard to fast data transmission.

According to example embodiments, a slip ring module includes a plurality of electrically conductive elements and a dielectric support body in which the electrically conductive elements are embedded. The material of the dielectric support body includes a ceramic, e.g., inorganic, material. The slip ring module is produced using an additive method such that the plurality of electrically conductive elements are each formed as a single piece. Each of the electrically conductive elements includes a first region, arranged as a slip ring, and a second region, arranged as a connecting conductor. The dielectric support body has webs between which cavities are located.

Connecting conductors include, for example, regions of the single-piece electrically conductive elements that conduct electrical signals or electrical power to the actual region of the sliding contact or, for example, to the slip ring (or away from the slip ring). The connecting conductors themselves or, for example, in conjunction with the surrounding web are rigid or stiff. In conventional slip ring modules, the electrical connection is often performed by flexible stranded wires.

For example, the ceramic material accounts for at least 80%, e.g., at least 90%, at least 95%, etc., of the total mass of the dielectric support body.

The additive method for producing the slip ring module may include a 3D printing method, e.g., a multi-material 3D printing method.

The slip ring module may be arranged as a component of a cylindrical slip ring unit, in which a stator element is in sliding contact with a slip ring of the slip ring module on the circumferential side. The slip ring has a circumferential surface, e.g., an outer circumferential surface extending around an axis.

Alternatively, the slip ring module may also be configured for a disk slip ring unit, in which a stator element is in sliding contact with a slip ring at the end face.

After being produced by the additive method, the slip rings can optionally be coated, e.g., with a precious metal.

The slip ring module is particularly well suited for the transmission of electrical power and/or electrical signals, e.g., for the transmission of information. The slip ring module can be used to transmit high-frequency signals in a comparatively simple manner.

The term cavity may be understood to mean a closed cavity or an open cavity. Furthermore, a web may be flat, for example, as a wall, or rod-shaped. For example, a web is a rigid structure.

According to example embodiments, the material of the electrically conductive elements includes silver. For example, the silver accounts for at least 80%, e.g., at least 90%, at least 95%, etc., of the total mass of the electrically conductive element. Alternatively, the material of the electrically conductive elements may also include copper. For example, the copper accounts for at least 80%, e.g., at least 90%, at least 95%, etc., of the total mass of the electrically conductive element.

For example, in a cross-section of the slip ring module, the connecting conductor is enclosed by the webs of the dielectric support body. Accordingly, a cavity of the dielectric support body is filled with the material of the electrically conductive elements.

For example, the webs of the dielectric support body are configured such that they have a circumferential shape in a cross-section of the slip ring module. In this configuration, a web delimits an inner cavity. Accordingly, the support body may have the shape of a polygon, e.g., a regular polygon. For example, the support body may have webs arranged in a honeycomb shape, so that the webs thus define a prism-shaped cavity with a hexagon as its base. The webs may also be configured to have a round cross section. Alternatively, the support body may also be arranged as a porous body with open and/or closed pores.

According to example embodiments, the slip ring module has at least two connecting conductors, in which a cross-section of the slip ring module a cavity is arranged between the connecting conductors.

For example, a cavity is arranged between two first regions arranged as slip rings.

A web may be arranged respectively between the two connecting conductors or between two slip rings so that the two connecting conductors or the two slip rings are not directly adjacent to the respective cavity lying therebetween.

For example, the material of the dielectric support body includes a glass-ceramic material. Thus, the term ceramic material should also to be understood as a material which is assigned to the group of glass-ceramics, i.e., for example, a material that includes or consists of a polycrystalline and a glassy phase. For example, the material of the dielectric support body may include aluminum oxide, silicon oxide, or silicon nitride.

For example, the slip ring module is formed such that at least one of the plurality of electrically conductive elements and the dielectric support body are arranged within one and the same cross-section of the slip ring module. This configuration is produced by an additive production method in which two different materials are printed within one layer or, for example, one cross-section of the slip ring module, e.g., the material for the electrically conductive elements and that for the dielectric support body. For example, the plurality of electrically conductive elements and the dielectric support body are sintered together simultaneously. For this purpose, the material for the electrically conductive elements may include silver and the material for the dielectric support body may include a glass-ceramic. With this combination, a suitable sintering temperature can be set without damaging any of the components.

For example, the slip ring module also has a component arranged as a bearing seat that is also produced in the course of the additive method. To simplify the process, the material of the component may be the same material as that of the electrically conductive elements. This component may also be sintered simultaneously together with the support body.

Further features and aspects of example embodiments of the present invention are described in more detail below with reference to the appended schematic Figures.

### BRIEF DESCRIPTION OF THE DRAWINGS

FIG. 1 is a longitudinal cross-sectional view of a slip ring module.

FIG. 2 is a cross-sectional view, taken from D-D, of a slip ring module.

FIG. 3 is another cross-sectional view, taken from E-E, of a slip ring module.

### DETAILED DESCRIPTION

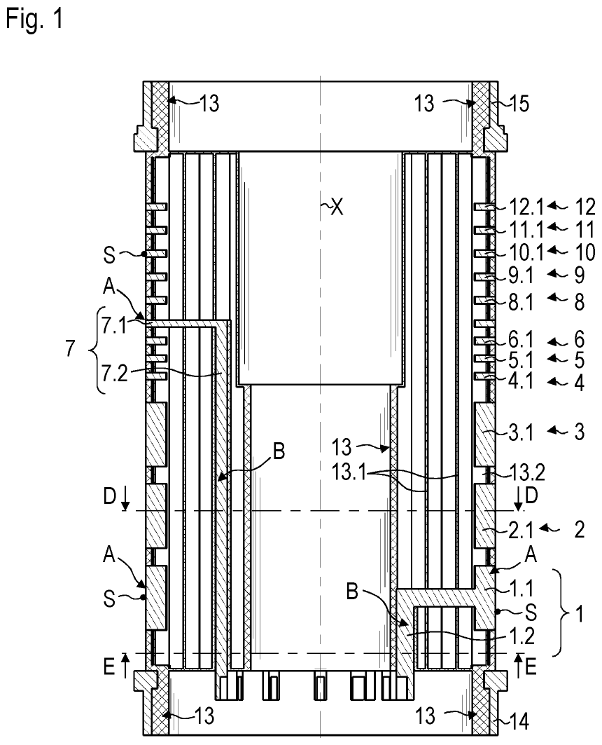

FIG. 1 is a longitudinal cross-sectional view of a slip ring module produced by an additive method. With this additive production method or, for example, 3D printing method, layers are built up one after the other, each extending in a plane (e.g., cross-section) perpendicular to an axis X, i.e., in FIG. 1, for example, from bottom to top. Two materials may be combined with each other in one layer such that electrically conductive and non-conductive materials may be processed additively in one and the same layer. For example, two light-polymerizable materials are used in the additive method, e.g., a silver-containing material and a glass-ceramic-containing material. This method is thus used to successively build up a body which, according to the terminology of additive manufacturing technology, is referred to as a green body.

This green body is placed in a sintering or, for example, firing oven for debinding. At elevated temperatures, the organic resin components or, for example, the binding agent decompose, in which the materials are simultaneously sintered together.

The slip ring module produced by such a method has electrically conductive elements 1 to 12 and a dielectric support body 13, in which the electrically conductive elements 1 to 12 are embedded in the support body 13. In addition, the additive method is used to produce two components 14, 15 arranged as bearing seats, which are firmly formed on the support body 13. The material of the electrically conductive elements 1 to 12 includes silver as a, e.g., substantial, component, and the material of the dielectric support body 13 includes a glass-ceramic material.

The electrically conductive elements 1 to 12 are each formed as a single piece. In sections, these each have a first region A, which in the subsequent intended operation is arranged in each case as a slip ring 1.1, 2.1, 3.1, 4.1, 5.1, 6.1, 7.1, 8.1, 9.1, 10.1, 11.1, 12.1. In the illustrated example embodiment, the slip rings 1.1, 2.1, 3.1, 4.1, 5.1, 6.1, 7.1, 8.1, 9.1, 10.1, 11.1, 12.1 have a cylindrical shape with an outer shell or circumferential surface S extending around the axis X. Furthermore, the electrically conductive elements 1 to 12 each have a second region B, which is arranged as a connecting conductor 1.2, 2.2, 3.2, 4.2, 5.2, 6.2, 7.2, 8.2, 9.2, 10.2, 11.2, 12.2 (see, e.g., FIG. 3) and extends parallel to the axis X at least in sections, for example.

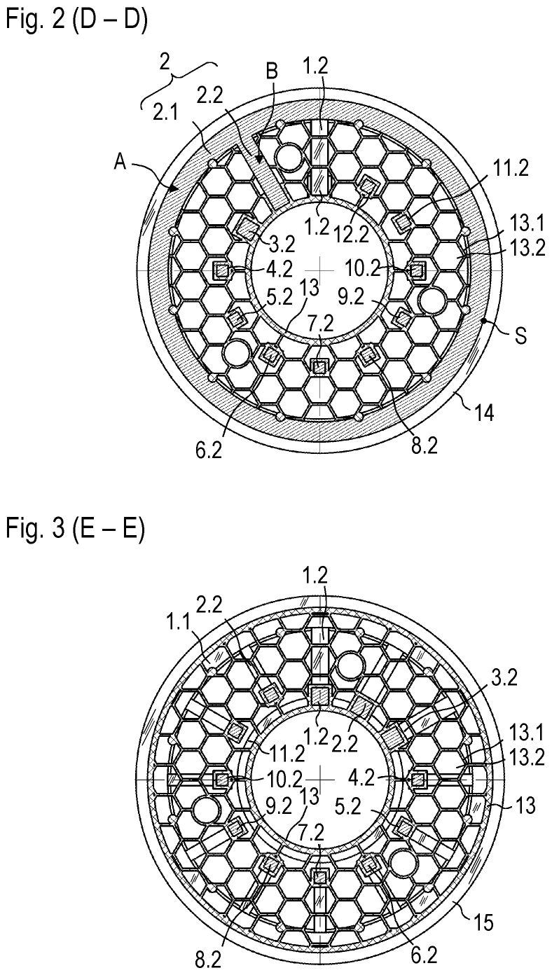

The dielectric support body 13 does not have a solid configuration, but has webs 13.1 between which cavities 13.2 are located. In the illustrated example embodiment, the webs 13.1 extend substantially with a direction component parallel to the X axis. For example, the webs 13.1, which may also be referred to as walls, have their longest extension along a direction oriented parallel to the axis X. As illustrated in FIGS. 2 and 3, the webs 13.1 are configured such that they have a circumferential shape in cross-section (e.g., in section D-D or E-E) of the slip ring module, so that a web 13.1 delimits an inner cavity 13.2. In the illustrated example embodiment, the webs 13.1 are configured such that they form the shape of a regular hexagon in cross-section, i.e., they are honeycomb-shaped. For example, the corresponding honeycombs penetrate the dielectric support body 13 and are open in the axial direction.

As illustrated, in a cross-section of the slip ring module, the connecting conductors 1.2, 2.2, 3.2, 4.2, 5.2, 6.2, 7.2, 8.2, 9.2, 10.2, 11.2, 12.2 are enclosed by the webs 13.1 of the dielectric support body 13, e.g., in the regions B in which the connection conductors 1.2, 2.2, 3.2, 4.2, 5.2, 6.2, 7.2, 8.2, 9.2, 10.2, 11.2, 12.2 extend parallel to the axis X. Thus, the electrically conductive elements 1 to 12 and the dielectric support body 13 are arranged within one and the same cross-section of the slip ring module.

The slip ring module is configured such that in a cross-section of the slip ring module, e.g., in cross-section E-E or D-D, one or a plurality of cavities 13.2 is/are arranged between two connecting conductors 1.2, 2.2, 3.2, 4.2, 5.2, 6.2, 7.2, 8.2, 9.2, 10.2, 11.2, 12.2. Likewise, one or a plurality of cavities 13.2 is/are arranged between the first regions A arranged as slip rings 1.1, 2.1, 3.1, 4.1, 5.1, 6.1, 7.1, 8.1, 9.1, 10.1, 11.1, 12.1, axially located between adjacent slip rings 1.1, 2.1, 3.1, 4.1, 5.1, 6.1, 7.1, 8.1, 9.1, 10.1, 11.1, 12.1.

The slip ring module is used to transmit currents and/or electrical signals, e.g., high-frequency signals. For this purpose, brushes are brought to the shell surfaces S of the first regions A arranged as slip rings 1.1, 2.1, 3.1, 4.1, 5.1, 6.1, 7.1, 8.1, 9.1, 10.1, 11.1, 12.1. For example, these brushes are in permanent sliding contact with the rotating shell surfaces S during a rotational movement of the slip ring module.

In order to be able to guarantee suitable operating characteristics, rolling bearings are installed in the slip ring unit with an axis of rotation that is congruent with the axis X. In the Figures, only the two components 14, 15 are visible, which are intended to serve as bearing seats for inner rings of the rolling bearings. These components 14, 15 are also produced using the additive method. The components 14, 15 are non-rotatably connected to the support body 13. For example, 3D printing can be utilized to create a form-locking connection between the support body 13 and the components 14, 15. For simplicity, the same material used for the electrically conductive elements 1 to 12 may be used as material for the components 14, 15.

Accordingly, the slip ring module may be designated as a rotor within a slip ring unit, while the brushes may be assigned to a stator. Via the connecting conductors 1.2, 2.2, 3.2, 4.2, 5.2, 6.2, 7.2, 8.2, 9.2, 10.2, 11.2, 12.2, the currents and/or signals may be tapped or introduced on the rotor side.

For example, the configuration of the support body 13 with its cavities 13.2 allows the slip ring module to transmit signals at high data rates, for example, for Ethernet, Sercos data connections or other real-time data connections. This characteristic ultimately results from the arrangement of webs 13.1 and cavities 13.2 as an insulator creating a support body 13 that considerably reduces the degree of coupling or, for example, crosstalk between, e.g., adjacent, electrically conductive elements 1 to 12.

Furthermore, due to the possibilities of the additive production method, the slip ring module has slip rings 1.1, 2.1, 3.1, 4.1, 5.1, 6.1, 7.1, 8.1, 9.1, 10.1, 11.1, 12.1 that have a comparatively small extension in the radial direction. This configuration results in a comparatively small electrical capacitance in the transmission path, so that even high-frequency signals may be transmitted well, which helps to increase the transmittable bandwidth.

In addition, the routing of the connecting conductors 1.2, 2.2, 3.2, 4.2, 5.2, 6.2, 7.2, 8.2, 9.2, 10.2, 11.2, 12.2, which is precisely defined compared to conventional slip ring modules, creates geometrical conditions that are always reproducible. This arrangement also reproducibly contributes to increased reliability in the transmission of high data rates within a type series.

What is claimed is:

1. A slip ring module, comprising:
a plurality of electrically conductive elements;
a dielectric support body, a material of the dielectric support body including a ceramic material;
wherein the slip ring module is additively produced;
wherein each electrically conductive element is formed as a single piece, includes a first region arranged as a slip ring, and a second region arranged as a connecting conductor; and
wherein the dielectric support body includes webs between which cavities are located.

2. The slip ring module according to claim 1, wherein the slip ring includes an outer circumferential shell surface.

3. The slip ring module according to claim 1, wherein a material of the electrically conductive elements includes copper or silver.

4. The slip ring module according to claim 1, wherein the connecting conductor is enclosed by webs of the dielectric support body.

5. The slip ring module according to claim 1, wherein the webs of the dielectric support body have a circumferential shape in a cross-section of the slip ring module, so that the web delimits an inner cavity.

6. The slip ring module according to claim 5, wherein the web is shaped as a polygon.

7. The slip ring module according to claim 5, wherein the web is shaped as a regular polygon.

8. The slip ring module according to claim 1, wherein, in a cross-section of the slip ring module, at least one of the cavities is arranged between two connecting conductors.

9. The slip ring module according to claim 1, wherein at least one of the cavities is arranged between two first regions.

10. The slip ring module according to claim 1, wherein the material of the dielectric support body includes a glass-ceramic material.

11. The slip ring module according to claim 1, wherein at least one of the electrically conductive elements and the dielectric support body are arranged within one and the same cross-section.

12. The slip ring module according to claim 1, wherein the electrically conductive elements and the dielectric support body are simultaneously sintered together.

13. The slip ring module according to claim 1, further comprising a bearing seat.

14. The slip ring module according to claim 13, wherein the bearing seat is additively-produced with the electrically conductive elements.

15. The slip ring module according to claim 1, wherein the material of the dielectric support body includes at least 80% of the ceramic material by mass.

16. The slip ring module according to claim 3, wherein the material of the electrically conductive element includes at least 80% copper or silver by mass.

17. The slip ring module according to claim 1, wherein the slip ring module is 3D printed.

18. The slip ring module according to claim 17, wherein the slip ring module is sintered.

19. The slip ring module according to claim 1, wherein the webs delimit axially extending hexagonal channels of the dielectric support body.

20. The slip ring module according to claim 1, wherein the ceramic material includes a glass-ceramic material.
